(19) United States
(12) Patent Application Publication
(10) Pub. No.: US 2020/0270789 A1
(43) Pub. Date: Aug. 27, 2020

(54) Sewing Machine Drive

(71) Applicant: Frankl & Kirchner GmbH & Co KG Fabrik für Elektromotoren u. elektrische Apparate, Schwetzingen (DE)

(72) Inventor: Wolfgang SINN, Rauenberg (DE)

(73) Assignee: Frankl & Kirchner GmbH & Co KG Fabrik für Elektromotoren u. elektrische Apparate, Schwetzingen (DE)

(21) Appl. No.: 16/646,710

(22) PCT Filed: Jul. 12, 2018
(86) PCT No.: PCT/EP2018/068860

§ 371 Date: Mar. 12, 2020

(30) Foreign Application Priority Data
Oct. 13, 2017 (DE) 10 2017 218 354.3

(51) Int. Cl. D05B 69/12; G01D 5/245

(52) U.S. Cl. CPC D05B 69/12; G01D 5/2457

(57) ABSTRACT

A magnetic encoder system (2) of a sewing machine drive comprises a disk (5), which is magnetized, an incremental track (8) and a reference track (9). The incremental track (8) extends completely around the disk (5) and has alternating pole elements (10), which serve as incremental markings. The reference track (9) is designed as a ring-shaped section on the disk (5) and has a monopole (11). The result is a magnetic encoder system (2), for example for a servo motor of a sewing machine.

### CROSS-REFERENCE TO RELATED APPLICATIONS

The present patent application claims the priority of German patent application DE 10 2017 218 354.3, the contents of which are incorporated by reference herein.

### TECHNICAL FIELD

The disclosure relates to a sewing machine drive and to a sewing machine with a sewing machine drive.

### BACKGROUND

A sewing machine drive is known in particular from DE 197 14 520 A1 and U.S. Pat. No. 5,860,377 A.

It is the object of the present disclosure to improve the known state of the art in such a manner that a sewing machine drive can be manufactured easily and inexpensively, and at the same time can be handled in a functionally reliable manner.

### SUMMARY

This task is achieved by a sewing machine drive having a disk made of magnetic material, an incremental track, and a reference track (9). The disk is magnetized. The incremental track extends completely around the disk and has alternating pole elements, which serve as incremental markings. The reference track is designed as a ring-shaped section on the disk and has a monopole.

The sewing machine drive thus has a reference track that includes a monopole. The term “monopole” refers to a magnetization of the reference track, with which the magnetic flux density of one pole has a much higher peak value than the magnetic flux density of the opposite pole, which is then negligible. A ratio between the peak values of the flux densities between the practically exclusively acting pole and the negligible opposite pole is at least greater than 5.

By designing the reference track with at least one monopole, the design effort is reduced compared to the systems known from the state of the art. The formation of a monopole can reduce errors and inaccuracies in the evaluation of the detectable signals. In addition, due to the design of the reference track with a monopole, larger manufacturing tolerances with magnetization are possible, which results in a simpler production of the encoder system in accordance with the invention.

The reference track can be formed on a magnetic, in particular ferritic disk, wherein the disk can be connected to a shaft, in particular a motor shaft, in a rotationally fixed manner. The monopole of the reference track only includes a partial section in the circumferential direction of the disk. In addition to the reference track, the disk also includes an incremental track, which is completely on the disk. By designing the reference track with a monopole, the mutual magnetic influence of the incremental track and the reference track is reduced compared to conventional encoder systems. Consequently, an increased functional reliability of the encoder system is guaranteed. Furthermore, more compact or smaller designs of the encoder system in accordance with the invention are conceivable, since the incremental track and the reference track can be closer together without influencing each other.

Advantageously, the incremental track and the reference track are formed in a manner circular and coaxial to each other. In particular, the reference track has a smaller radius than the incremental track, but the opposite formation is also possible. At the same time, the tracks can be formed to be coaxial with the shaft. It is also conceivable to form the tracks eccentrically to each other and to the shaft and/or in an angular, in particular polygonal, for example pentagonal or hexagonal, manner.

The incremental track along with the reference track can be attached to a top side and/or bottom side of the disk and/or to an outer jacket wall of the disk.

It is also conceivable that other tracks are used in addition to the reference track and the incremental track. The other tracks are advantageously formed as a partial section along a circumference of the disk and are located at a different position on the disk from the incremental track and the reference track. Advantageously, the other tracks have monopoles.

The detectable signals of the tracks can be fed to different signal evaluation units. In particular, magnetoresistive sensors, preferably Hall sensors, are used to evaluate the detectable signals.

A sewing machine drive with an encoder system enables the optimized ability to control the drive, in particular of the sewing machine motor, and can thus facilitate the handling of a sewing machine.

An encoder system is known from DE 10 2015 226 666 A2. Further encoder systems are known from US 2016/0146630 A1, DE 39 90 206 T5, DE 10 2011 053 309 A1, US 2015/0091554 A1 and U.S. Pat. No. 4,551,676 A.

A sewing machine drive wherein the disk has a recess between the incremental track and the reference track makes it possible to reduce errors and inaccuracies in the evaluation of the detectable signals. Crosstalk, in particular that induced by magnetic fields, between the incremental track and the reference track is avoided. In accordance with a particularly advantageous design, the disk has a recess between the incremental track and the reference track, which is formed in a completely circumferential manner. Alternatively, the recess can also be designed as a ring section on the disk. Advantageously, the recess is formed on the section of the disk on which the reference track is formed. Thereby, the section recess on the disk can extend by the same circumferential extent as the reference track. The recess can be used to create an air gap between the incremental track and the reference track, thus counteracting any undesirable influence on the two tracks.

A sewing machine drive wherein the monopole (11) has a first magnetic flux density (B₁) in a first area that is greater by at least a factor of 10 or 20 than a second magnetic flux density (B₂) in at least a second area enables a safe and trouble-free determination of the reference track by the corresponding signal evaluation unit. In particular, the magnetic field strength or the magnetic flux density, as the case may be, in the first area is greater by a factor of 15 to 25, advantageously by a factor of 20, than the magnetic field strength or the magnetic flux density, as the case may be, in the second area.

A sewing machine drive wherein the monopole extends over a circumference of at least one pole element of the incremental track enables a reliable and interference-free determination of the reference track by the corresponding signal evaluation unit. In particular, the monopole can extend over the circumference of two or more pole elements of the incremental track. Advantageously, the monopole extends over the circumference of one pole element of the incremental track.

A sewing machine drive wherein the reference track has a plurality of monopoles in a circumferential direction enables the detection of the direction of rotation. Thereby, the number of monopoles can vary. In particular, two or more monopoles are arranged at the reference track, advantageously four monopoles, but more monopoles are also conceivable. Advantageously, the monopoles, regardless of their number, are equally spaced in the circumferential direction of the reference track. In addition, the monopoles can have different circumferential extensions, in particular with regard to the circumference of the pole elements of the incremental track. In the case of a particularly advantageous design of the reference track, starting from a first monopole, the circumferential extension of the next monopole increases by the circumferential extension of an additional pole element of the incremental track.

A sewing machine drive wherein the reference track serves for zero-point referencing serves for the zero point referencing of the rotor, by which the detectable signals, in particular in the case of a plurality of monopoles on the reference track, can be synchronized with the machine control device to which the encoder system is coupled. In particular. the machine control device is a sewing machine control device.

With a sewing machine drive which further comprises an evaluation unit with an integrated microcontroller and magnetic sensors, the evaluation of the detectable signals is carried out via an evaluation unit with an integrated microcontroller and magnetic sensors, by which a particularly compact encoder system is provided.

A sewing machine drive which further comprises an additional, separate magnetic sensor enables an independent zero point referencing.

The advantages of a sewing machine with the disclosed sewing machine drive correspond to the advantages already explained above with reference to the sewing machine drive.

### BRIEF DESCRIPTION OF THE DRAWINGS

Exemplary embodiments of the invention are explained in more detail on the basis of the drawing.

FIG. 1 shows perspectively an encoder system assembly for mounting on a servo motor of a sewing machine.

FIG. 2 is a perspective top view of the encoder system assembly.

FIG. 3 is a perspective detailed view of a magnetic encoder system in accordance with a first exemplary embodiment.

FIG. 4 is an enlarged view of the magnetic encoder system in the area of the monopole in accordance with FIG. 3.

FIG. 5 is a process diagram of the magnetic flux density B of the reference track of the magnetic encoder system in accordance with FIG. 3.

FIG. 6 is a sectional view of the magnetic encoder system in accordance with FIG. 3.

FIG. 7 is a perspective detailed view of a magnetic encoder system in accordance with a second exemplary embodiment.

### DETAILED DESCRIPTION

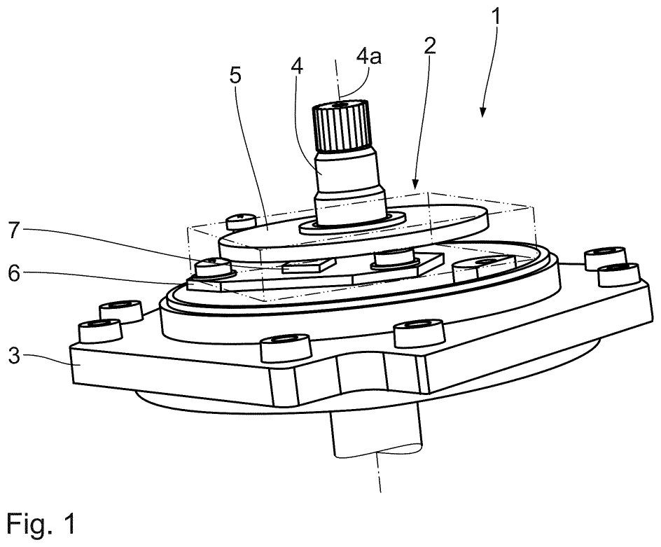

With reference to FIGS. 1 to 6, a first exemplary embodiment of a magnetic encoder system for a sewing machine in the form of a sewing machine servo motor is described below.

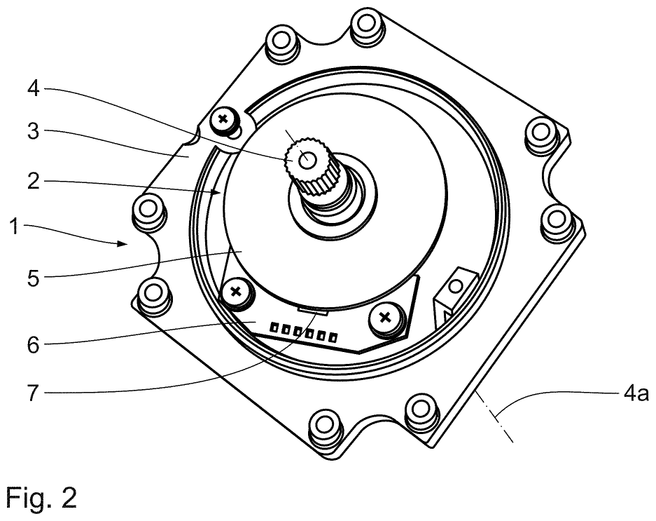

FIG. 1 and FIG. 2 show an encoder system assembly 1, which is used to attach a magnetic encoder system 2 to a servo motor for a sewing machine. The servo motor is not shown for reasons of clarity, but its position is indicated by a motor shaft 4 with a shaft axis 4a. In addition to the magnetic encoder system 2, the assembly 1 includes a mounting flange 3, by means of which the magnetic encoder system 2 is attached to the servo motor. Each of the mounting flange 3 and the magnetic encoder system 2 has an opening starting from its center, which allows it to be attached to the motor shaft 4 of the servo motor. The openings are formed to be circular in shape.

The magnetic encoder system 2 comprises a ring-shaped disk 5 made of magnetic, in particular ferritic material. Thereby, the disk 5 is connected to the motor shaft 4 so that a rotation of the motor shaft 4 simultaneously results in rotation of the disk 5.

The mounting flange 3 has a plate 6 on the side turned towards the disk 5, by means of which an evaluation unit 7 is attached to the mounting flange 3. The evaluation unit 7 is used to read out an incremental track 8 attached to the disk 5 along with a reference track 9. The mounting flange 3 and the evaluation unit 7 on it are designed to be stationary. This means that a rotation of the motor shaft 4 does not cause rotation of the mounting flange 3 and the evaluation unit 7.

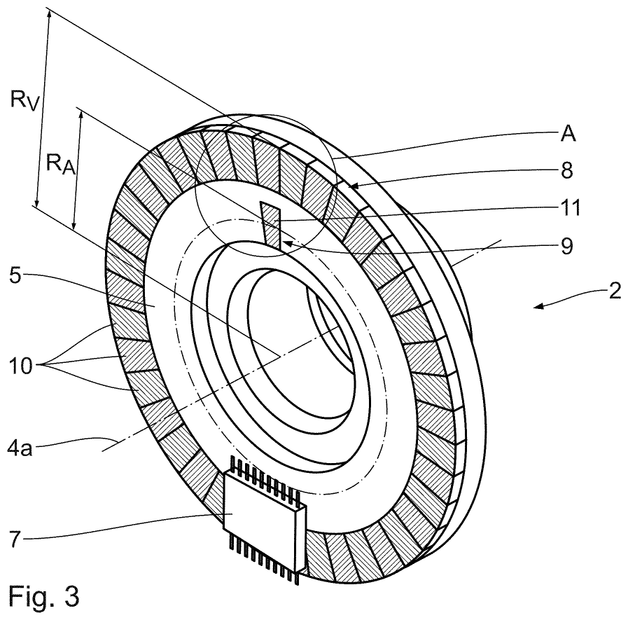

FIG. 3 shows the magnetic disk 5 in accordance with the first exemplary embodiment. The incremental track 8 along with the reference track 9 are formed to be circular in shape and extend along the circumference of the magnetic disk 5, wherein the incremental track 8 is attached entirely to the circumference, while the reference track 9 comprises only a partial section of the circumference. The incremental track 8 has alternating pole elements 10. In contrast, the reference track 9 comprises exactly one monopole 11. Both tracks 8, 9 are arranged in a manner coaxial to each other and coaxial to the motor shaft 4. The reference track 9 has a radius R_{A} that is smaller than a radius R_{V} of the incremental track 8.

The evaluation unit 7 is mounted opposite the disk 5 via the plate 6 on the mounting flange 3 and is used to read out the incremental track 8 along with the reference track 9. Thereby, the evaluation unit 7 is arranged in such a manner that a first magnetic sensor detects the incremental track 8 and an additional magnetic sensor detects the reference track 9. The two magnetic sensors are arranged in a manner radially offset to each other and are not shown in the drawings for reasons of clarity.

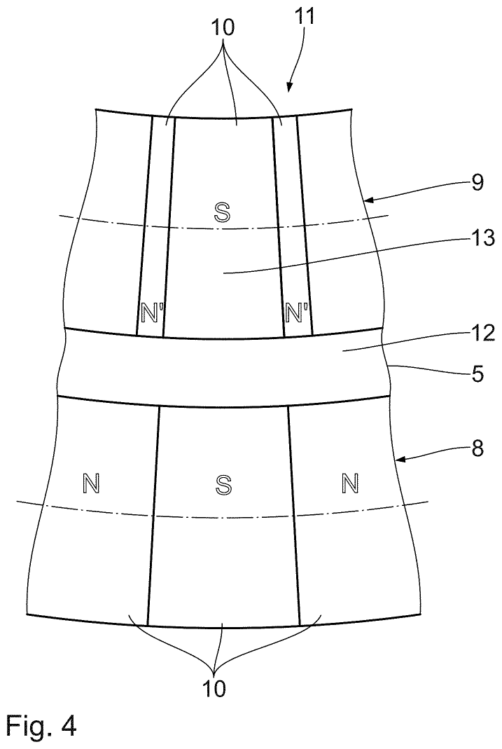

From the enlarged view of the magnetic encoder system in FIG. 4, it is clear that the monopole 11 of the exemplary embodiment shown can be understood as a structure of pole elements 10 with a south pole S extending in the circumferential direction of the reference track 9, which is bounded by two opposite and very weakly defined quasi-north pole sections N′. The two quasi-north pole sections N′ represent an opposite pole of the south pole S and together with it form the monopole 11. The structure of the monopole 11 can also be understood in such a manner that the south pole S is composed of two south pole sections, each of which includes one of the quasi-north pole sections N′. In the area of the south pole S, there is a strong magnetic field strength H or magnetic flux density B, whereas, in the area of the quasi-north pole sections N′, there is only a very weak magnetic field strength H or magnetic flux density B.

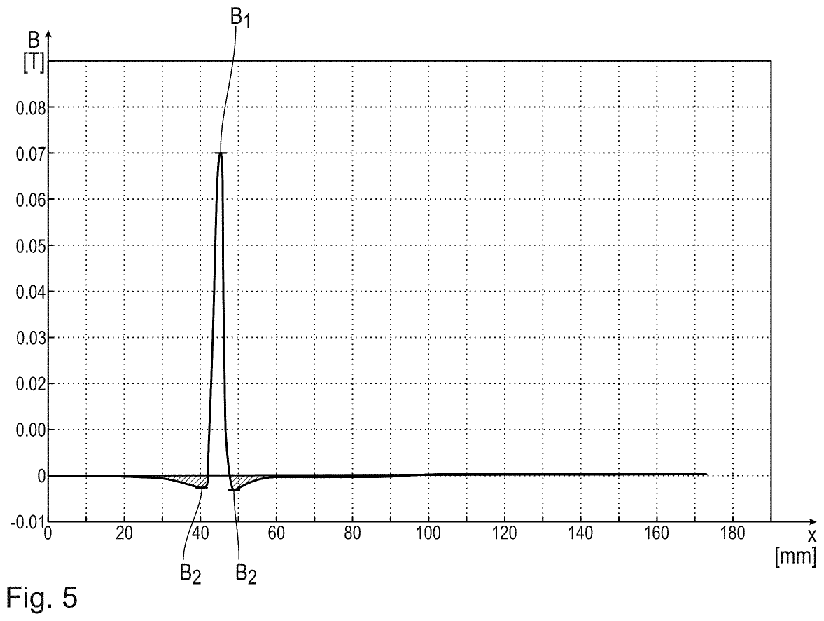

The diagram illustrated in FIG. 5 shows a smoothed curve of the magnetic flux density B (y-axis) over the circumferential extension (x-axis) of the reference track 9 in accordance with the first exemplary embodiment. No magnetic flux density B can be measured in the non-magnetized areas of the reference track 9 beyond the monopole 11. In the circumferential area of the quasi-north pole sections N′ of the monopole 11, a maximum value of the magnetic flux density B₂ is much weaker than a maximum value of the magnetic flux density B₁ in the area of the circumferential extension of the south pole S of the monopole 11. In accordance with the exemplary embodiment shown, the magnetic flux density B₁ is greater by a factor of 23 than the respective magnetic flux densities B₂. The ratio |B₁|/|B₂| can be greater than 10, can be greater than 15, can be greater than 20 and can also be greater than 23.

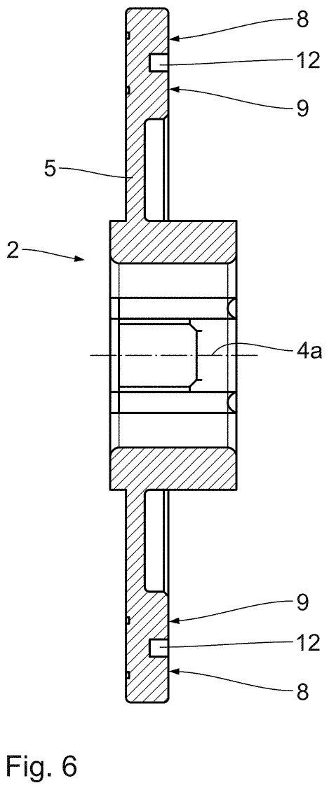

FIG. 6 shows a sectional view of the disk 5 of the magnetic encoder system 2. The disk 5 has a recess 12 in the circumferential direction between the reference track 9 and the incremental track 8. In the exemplary embodiment shown, the recess 12 is formed in a completely circumferential manner and serves to create an air gap between the incremental track 8 and the reference track 9. This counteracts any influence of the two tracks 8 and 9 among each other. In particular, this effectively prevents magnetic field-induced crosstalk between the tracks 8 and 9.

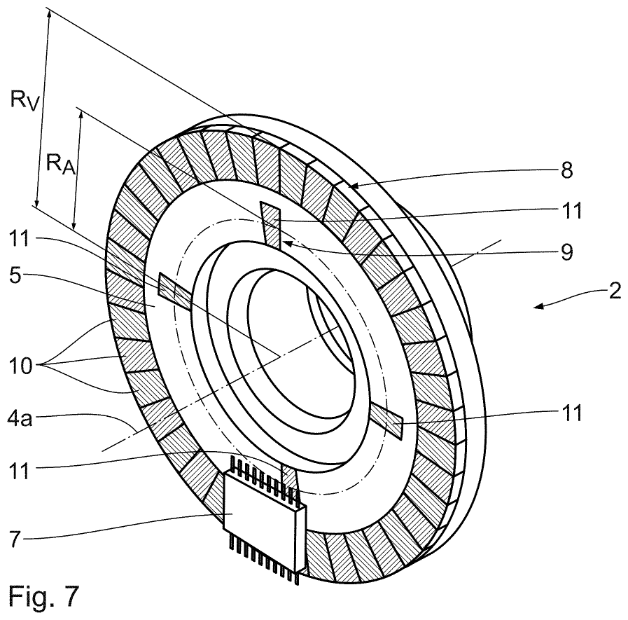

In the following, with reference to FIG. 7, a second exemplary embodiment of the magnetic encoder system for a sewing machine drive is described. Identical parts receive the same reference signs as with the first exemplary embodiment, the description of which is referred to here. The central difference compared to the first exemplary embodiment is that, on the reference track 9, a plurality of the monopoles 11 is formed in the circumferential direction. Thereby, the monopoles 11 are arranged at a 90° angle to each other. It is also conceivable to have a different number of the monopoles 11 on the reference track 9 instead of four monopoles 11. The monopoles 11 of the reference track 9 have the circumferential extension of a pole element 10 of the incremental track 8. However, the circumferential extensions of such monopoles can differ among each other.

Various other variants of the encoder system assembly 1 not shown here are conceivable. For example, incremental track 8 can be located on a top side and the reference track 9 can be located on a bottom side of the disk 5. It is also possible to arrange the incremental track 8 and/or the reference track 9 on an outer jacket wall of the disk 5.

1.-10. (canceled)

11. A sewing machine drive with a magnetic encoder system (2), comprising:
a disk (5) made of magnetic material;
an incremental track (8); and
a reference track (9),
wherein the disk (5) is magnetized,
wherein the incremental track (8) extends completely around the disk (5) and has alternating pole elements (10), which serve as incremental markings, and
wherein the reference track (9) is designed as a ring-shaped section on the disk (5) and has a monopole (11).

12. The sewing machine drive according to claim 11, wherein the disk (5) has a recess (12) between the incremental track (8) and the reference track (9).

13. The sewing machine drive according to claim 11, wherein the monopole (11) has a first magnetic flux density (B₁) in a first area that is greater by at least a factor of 10 than a second magnetic flux density (B₂) in at least a second area.

14. The sewing machine drive according to claim 13, wherein the first magnetic flux density (B₁) is greater by at least a factor of 20 than the second magnetic flux density (B₂).

15. The sewing machine drive according to claim 11, wherein the monopole (11) extends over a circumference of at least one pole element (10) of the incremental track (8).

16. The sewing machine drive according to claim 11, wherein the reference track (9) has a plurality of monopoles (11) in a circumferential direction.

17. The sewing machine drive according to claim 11, wherein the reference track (9) serves for zero-point referencing.

18. The sewing machine drive according to claim 11, further comprising an evaluation unit (7) with an integrated microcontroller and magnetic sensors.

19. The sewing machine drive according to claim 11, further comprising an additional, separate magnetic sensor.

20. A sewing machine with a sewing machine drive according to claim 19.
